(19) United States
(12) Patent Application Publication
(10) Pub. No.: US 2026/0058686 A1
(43) Pub. Date: Feb. 26, 2026

(54) INTEGRATED RADIO FREQUENCY TRANSMIT-RECEIVE SWITCH WITH EXTERNAL SWITCHING OPTION

(71) Applicant: Cypress Semiconductor Corporation, San Jose, CA (US)

(72) Inventors: Burcin Baytekin, Menlo Park, CA (US); Shu-Hsien Liao, San Jose, CA (US)

(73) Assignee: Cypress Semiconductor Corporation, San Jose, CA (US)

(21) Appl. No.: 18/810,730

(22) Filed: Aug. 21, 2024

(51) Int. Cl. H04B 1/44; H04B 1/04

(52) U.S. Cl. CPC H04B 1/44; H04B 1/0483; H04B 2001/0408

(57) ABSTRACT

The embodiments described herein are directed at techniques to perform T/R switching internally on a transceiver chip. An example transceiver chip includes a power amplifier coupled to an output terminal of the transceiver chip and a low noise amplifier coupled to an input terminal of the transceiver chip. The input terminal and the output terminal are separate terminals external to the transceiver chip. The transceiver chip also includes a shunt switch coupled in parallel with the low noise amplifier between the input terminal and ground and a control circuitry to activate the shunt switch to couple the input terminal to ground when the power amplifier is turned on.

### TECHNICAL FIELD

The present disclosure relates generally to co-located communication devices that each employ any of a variety of communication protocols (e.g., Wi-Fi™ and Bluetooth™), and more particularly to techniques for switching between a transmit mode and a receive mode.

### BACKGROUND

Various communication devices may include transceivers configured to transmit/receive data using any of a variety of communication protocols. For example, a transceiver can transmit/receive signals using the Wi-Fi protocol, the Bluetooth protocol, or the WiMAX protocol, among others. In some cases, the transceiver's transmitting and receiving components are coupled to the same antenna, which is used for both transmitting and receiving Radio Frequency (RF) signals. In such cases, a switching device may be used to couple the antenna to the transmitter during the transmit mode and to the receiver during the receive mode.

### BRIEF DESCRIPTION OF THE DRAWINGS

The present embodiments are illustrated by way of example, and not of limitation, in the figures of the accompanying drawings.

FIG. 1 is a block diagram illustrating a transceiver in accordance with embodiments of the present disclosure.

FIGS. 2A, 2B, and 2C describe example configurations for incorporating the transceiver in a wireless communication apparatus.

FIG. 2B is a block diagram showing the transceiver integrated within the apparatus in accordance with another example implementation.

FIG. 2C is a block diagram showing the transceiver integrated within an apparatus in accordance with another example implementation.

FIG. 3 is a circuit diagram of the transceiver disposed within an apparatus such that the antenna is coupled directly to the input terminal in accordance with some embodiments of the present disclosure.

FIG. 4 is a circuit diagram of the transceiver disposed within an apparatus such that the antenna is coupled directly to the output terminal in accordance with some embodiments of the present disclosure.

FIG. 5 is a flow diagram of a method for operating an internal (on-chip) T/R switching device, in accordance with some embodiments of the present disclosure.

FIG. 6 is a block diagram illustrating a communication device, in accordance with some embodiments of the present disclosure.

### DETAILED DESCRIPTION

In the following description, for purposes of explanation, numerous specific details are set forth in order to provide a thorough understanding of the present embodiments. It will be evident, however, to one skilled in the art that the present embodiments may be practiced without these specific details. In other instances, well-known circuits, structures, and techniques are not shown in detail, but rather in a block diagram in order to avoid unnecessarily obscuring an understanding of this description.

Reference in the description to “one embodiment” or “an embodiment” means that a particular feature, structure, or characteristic described in connection with the embodiment is included in at least one embodiment. The phrase “in one embodiment” located in various places in this description does not necessarily refer to the same embodiment.

Many RF communication devices send and receive data wirelessly using a transceiver that combines wireless transmission and receiving circuitry in a single integrated circuit chip. In a typical transceiver, the transmitter includes a power amplifier (PA) and the receiver includes a low noise amplifier (LNA). In many cases, the transceiver's transmitter and receiver share a common antenna, which is used both for transmitting and receiving RF signals. In such cases, an RF Transmit-Receive (T/R) switch may be used to switch the antenna coupling between the wireless transmitter and the wireless receiver depending on the operating mode. While the transmitter is active, the T/R switch protects the wireless receiver (e.g., the LNA) and reduces parasitic loading of the receiver at the output of the transmitter (e.g., the PA). Likewise, when the receiver is active, the T/R switch reduces parasitic loading of the inactive transmitter.

Conventional T/R switches are usually external to the transceiver chip. For example, the T/R switch and the transceiver chip may be mounted to a printed circuit board (PCB) and coupled via conductive traces on the PCB. These types of off-chip T/R switches increase the cost of the overall transceiver implementation and take up considerable area on the PCB. In some cases, the T/R switch may be included in separate chip, such as a frontend module.

The embodiments described herein provide a transceiver chip with an internal T/R switching capability that eliminates the demand for an external T/R switch. One way to incorporate internal T/R switching in a transceiver chip would be to couple the transmitter and the receiver to a single output terminal through an on-chip multiplexer. However, many users may prefer to use off-chip T/R switches or a separate frontend module with its own T/R switching capability, which would not be possible if the transceiver chip has only a single output terminal.

Accordingly, the internal T/R switching design described above would demand that two different form factors be maintained for nearly the same chip, which increases the costs of chip design (e.g., tape-out) and supply chain management. To address these and other deficiencies of conventional T/R switching techniques, the present disclosure provides a transceiver chip that has an internal (i.e., on-chip) T/R switching capability while also maintaining separate transmit and receive terminals. This allows the transceiver chip to be used in both types of systems, those that make use of the internal T/R switch and those that have a separate external T/R switch. Additionally, the design of the transceiver chip ensures that RF performance loss is minimal when used in conjunction with an external T/R switch. In this way, the solution described allows users to take advantage of the cost savings and reduced board area of internal T/R switching while also allowing users to use the same transceiver chip in system designs that have external (i.e., off-chip) T/R switching if they prefer. Offering integrated and external switching options in the same chip enables device manufacturers to realize the cost savings of the internal T/R switching option while also avoiding the added costs involved in designing two different chips for the two different types of applications.

In embodiments described herein, the internal T/R switching capability is provided by an on-chip shunt switch at the input of the LNA. If the internal T/R switching capability is used, a small number of inexpensive off-chip components may be added to the PCB to tune the system's electrical characteristics for both operating modes. During RF transmission, the shunt switch (in combination with package parasitics and other on-chip and off-chip components) creates a high impedance parallel resonance at the transmitter output, minimizing the parasitic loading seen by the PA output and protecting the LNA from large voltage swings generated by transmitter. The lack of series elements on both the LNA input and the PA output paths minimizes parasitic loss in either mode, which alleviates electrostatic discharge (ESD) risks and long-term reliability concerns due to large voltage swings during transmission.

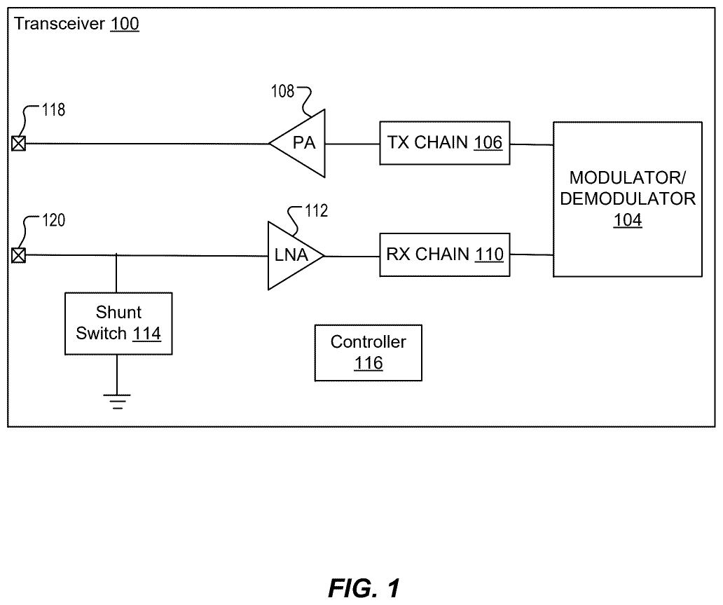

FIG. 1 is a block diagram illustrating a transceiver in accordance with embodiments of the present disclosure. The transceiver 100 may be configured for use with any suitable communication protocol, including WiFi, Bluetooth, 4G, 5G, and others. The transceiver 100 may be implemented on a single integrated circuit chip (i.e., a single die).

The transceiver 100 may include a modulator/demodulator 104 communicatively coupled to one or more off-chip electronic devices. The modulator/demodulator 104 can receive digital signals from an off-chip source, encode the digital signals to be suitable for transmission, and send the encoded signals to a transmit chain 106. The transmit chain 106 may include signal processing components such as a digital-to-analog converter (DAC), mixer, RF filters, and the like. The output of the transmit chain 106 is used to control a power amplifier (PA) 108 which generates the RF signal to be wirelessly transmitted.

The modulator/demodulator 104 is also coupled to a receive chain 110. RF signals received by the transceiver 100 are received at the low noise amplifier (LNA), which amplifies the RF signals and couples the amplified signal to the receive chain 110. The receive chain 110 may include signal processing components such as a mixer, RF filters, an analog-to-digital converter (ADC), and the like. The output of the receive chain is sent to the modulator/demodulator 104, which decodes the signals and sends the decoded signals to off-chip electronic devices.

The transceiver 100 also includes external terminals 118 and 120 that enable internal components of the transceiver 100 to be coupled to external components (not shown) such as an antenna, antenna array, a front-end module, and others. The output of the PA 108 is coupled to the output terminal 118 for outputting the RF signals to be transmitted, and the input of the LNA 112 is coupled to a separate input terminal 120 for receiving RF signals that have been received wirelessly. The terminals 118 and 120 may be pins or conductive pads (e.g., Ball Grid Array (BGA)), for example. Although not shown, it will be appreciated that, the input terminal 120 and output terminal 118 may be coupled to one or more antennas configured for wireless transmission and reception of RF signals when implemented in a wireless communication device. The input port 120 and the output port 118 may be impedance matched to the standard impedance of the RF system in which it is to be deployed (e.g., 50 Ohm, 75 Ohm). Accordingly, various impedance matching components (e.g., inductors, capacitors, etc.) may be implemented internally within the transceiver 100 and/or externally (e.g., on the same PCB as the transceiver 100).

The transceiver 100 also includes a shunt switch 114 that provides the internal T/R switching capability of the transceiver 100. The shunt switch 114 may be a single transistor or a stack of transistors coupled in series, which may provide more resilience against ESD discharge.

The transceiver 100 may also include a controller 116 that controls the shunt switch 114 in response to the transceiver's operating mode (e.g., transmit mode or receive mode). The controller 116 may include any suitable circuitry for performing its functions, such as logic circuits, microprocessors, etc. The controller 116 may also perform other functions of the transceiver 100 that are outside the scope of the present disclosure.

The shunt switch 114 is coupled in parallel with the LNA 112 between the input terminal 120 and ground. When the transceiver 100 is in transmit mode and the power amplifier is turned on, the controller 116 activates (i.e., closes) the shunt switch 114 to couple the input terminal 120 to ground. When closed, the shunt switch 114 shunts any current received at the input terminal 120 due to parasitic effects to ground, thereby protecting the LNA 112.

When the transceiver 100 is in receive mode and the power amplifier is turned off, the controller 116 deactivates (i.e., opens) the shunt switch 114 so that the input terminal 120 is no longer coupled to ground, allowing the signal at the input terminal 120 to be received at the input of the LNA 112.

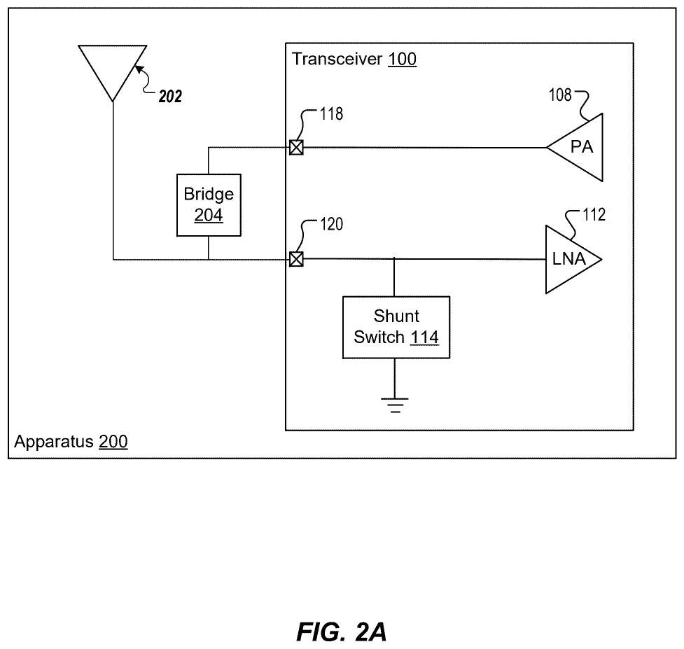

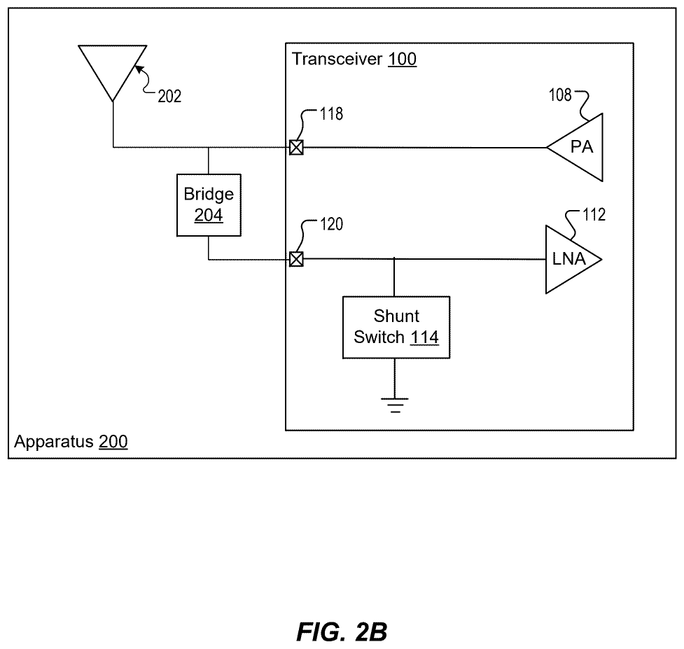

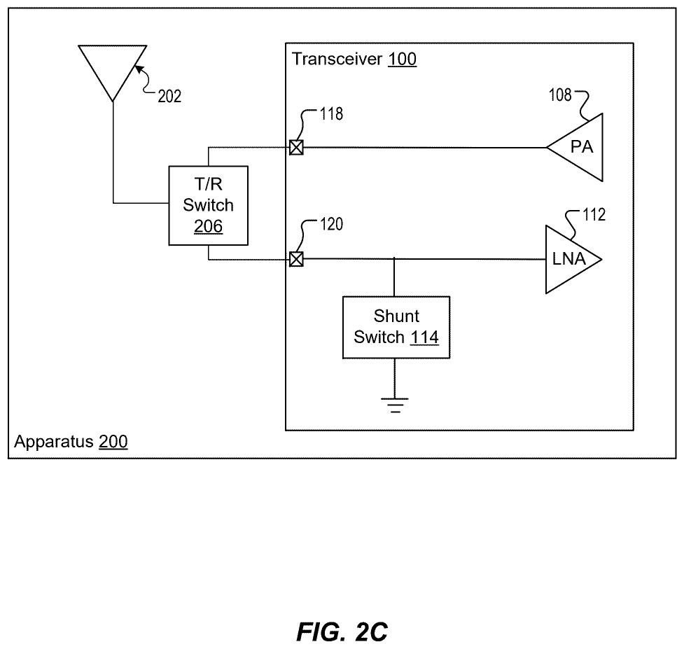

The transceiver 100 disclosed herein provides internal T/R switching capability while also being suitable for systems that use a T/R switch external to the transceiver chip 100. FIGS. 2A, 2B, and 2C describe example configurations for incorporating the transceiver 100 in a wireless communication apparatus.

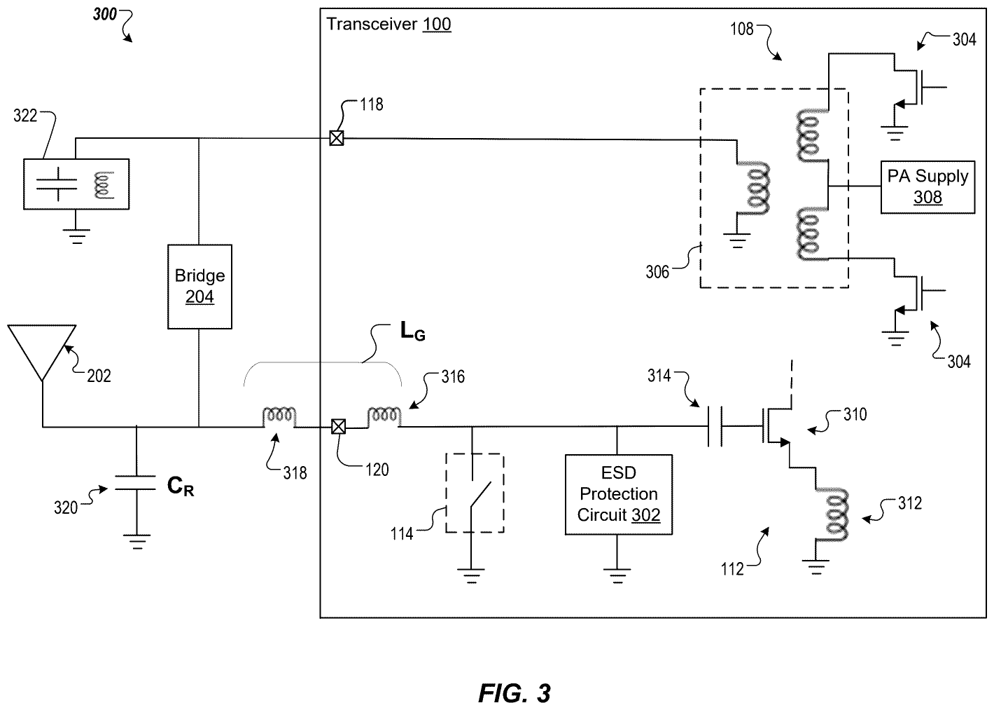

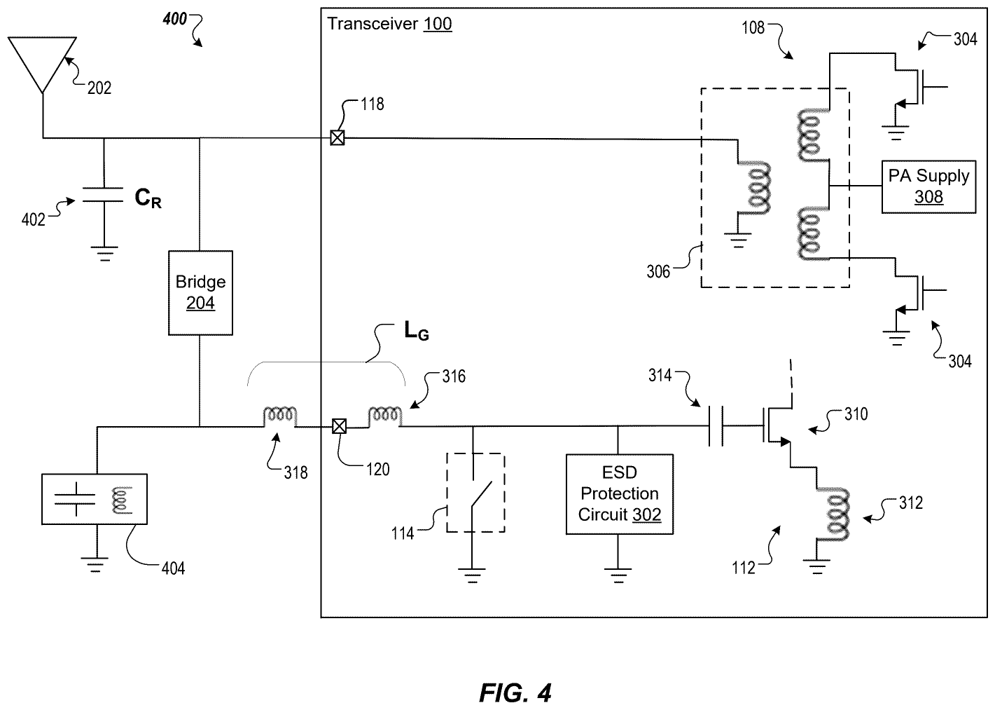

It will be appreciated FIG. 1 represents an example embodiment of a transceiver with internal T/R switching capabilities and that an actual implementation of the described embodiments may include additional or fewer components. Additional details of the transceiver 100 and its operation are described further in relation to FIGS. 3 and 4.

FIG. 2A is a block diagram showing the transceiver 100 integrated within an apparatus 200 in accordance with an example implementation. The apparatus 200 shown in FIGS. 2A-2C may be any suitable electronic device configured for wireless communication. For example, the apparatus 200 may be a smart phone, personal computer (PC) (e.g., desktop or laptop), tablet computer, wireless router, a software-enabled access point (SoftAP), Internet-of-Things (IoT) device, and others. The transceiver 100 may be coupled to a PCB of the apparatus 200.

As shown in FIG. 2A, the apparatus 200 includes the transceiver 100 described in relation to FIG. 1. According to the implementation shown in FIG. 2A, the apparatus 200 is configured to make use of the internal T/R switching capability of the transceiver 100. Thus, the apparatus 200 does not have an external T/R switch coupled to the terminals 118 and 120 of the transceiver 100. As described above, the shunt switch 114 is activated during transmit mode to couple the input terminal 120 to ground and deactivated during receive mode.

Additionally, in the implementation shown in FIG. 2A, the antenna 202 is coupled to the input terminal 120 directly and coupled to the output terminal 118 through a bridge 204. The word “directly” in this context means that the antenna 202 is not coupled to the input terminal 120 through the bridge component 204. Accordingly, there may be additional components between the antenna 202 and the input terminal 120 while still being considered “directly” coupled to the input terminal 120. For example, one or more analog signal conditioning and/or switching components (not shown) may be disposed between the antenna 202 and the input terminal 120, including RF filters, diplexers, impedance matching components, and others. Additionally, the antenna 202 may be an antenna with a single radiating element or an antenna array with multiple radiating elements.

The bridge 204 includes one or more electrical components configured to couple the PA 108 to the antenna 202 during transmit mode. In some embodiments, the bridge 204 may be nothing more than a conductor, such as a conductive trace disposed on the PCB. In some embodiments, the bridge 204 may also include a series capacitor or a series inductor. The components of the bridge 204 may be selected to provide suitable electrical performance during both operating modes as described further below in relation to FIG. 3.

FIG. 2B is a block diagram showing the transceiver 100 integrated within the apparatus 200 in accordance with another example implementation. The implementation shown in FIG. 2B is similar to that of FIG. 2A, except that the antenna 202 is coupled to the output terminal 118 directly and coupled to the input terminal 120 through the bridge 204. According to the implementation shown in FIG. 2B, the apparatus 200 is configured to make use of the internal T/R switching capability of the transceiver 100. Thus, the apparatus 200 does not have an external T/R switch coupled to the terminals 118 and 120 of the transceiver 100.

The choice of whether the couple the antenna 202 directly to the input terminal 120 (as in FIG. 2A) or directly to the output terminal 118 (as in FIG. 2B) may be made in consideration of the other design characteristics of the apparatus and the desired electrical performance of each operating mode. As in FIG. 2A, the bridge 204 may be nothing more than a conductor, such as a conductive trace disposed on the PCB, or may also include a series capacitor or series inductor.

FIG. 2C is a block diagram showing the transceiver 100 integrated within an apparatus 200 in accordance with another example implementation. The apparatus 200 includes the transceiver 100 described in relation to FIG. 1. However, in the implementation shown in FIG. 2C, the apparatus 200 is configured for external (e.g., off-chip) T/R switching. Thus, the apparatus 200 includes an external T/R switch 206 coupled to the terminals 118 and 120 of the transceiver 100. During transmit mode, the T/R switch 206 couples the antenna 202 to the output terminal 118 and the PA 108. During receive mode, the T/R switch 206 couples the antenna 202 to the input terminal 120 and the LNA 112. Although not shown, additional ESD protection circuitry may be included on the PCB to protect the T/R switch 206 from electrostatic discharge and large voltage swings potentially caused by the PA 108.

In the implementation shown in FIG. 2C, the operation of the shunt switch 114 will have little to no effect on the switching operations performed by the apparatus 200 through the T/R switch. In some embodiments, the shunt switch 114 may continue to operate in accordance with process described above, i.e., the shunt switch 114 may be activated during transmit mode and deactivated during receive mode. In some embodiments, the shunt switch 114 may be deactivated so that the shunt switch 114 stays open through both the transmit and the receive modes.

FIG. 3 is a circuit diagram of the transceiver 100 disposed within an apparatus 300 such that the antenna 202 is coupled directly to the input terminal 120 in accordance with some embodiments of the present disclosure. The apparatus 300 may be any suitable electronic device configured for wireless communication. FIG. 3 is a more detailed representation of the example implementation shown in FIG. 2A.

In this embodiment, the transceiver's PA 108 is a balanced differential power amplifier, which includes a pair of power switches 304 (e.g., field effect transistors) coupled to a DC supply voltage (PA supply 308) through a balun 306. The gates of the switches 304 are controlled to generate a differential signal. The balun 306 converts the differential signal generated by the power switches 304 into a single ended signal, which is provided to the output terminal 118. The balun 306 also isolates the power amplifier from the output terminal 118 and provides an impedance transformation.

The LNA 112 in this embodiment includes an amplifier 310 coupled in series with an inductor 312. Additionally, a series capacitor 314 may be coupled at the input of the amplifier 310. The transceiver 100 may also include an ESD protection circuit 302 coupled in parallel to the LNA 112.

The ESD protection circuit 302 is configured to protect the LNA 112 from electrostatic discharge and large voltage swings that could potentially be caused by the PA 108. However, in the embodiments disclosed herein, the existing ESD protection circuit 302 designed to protect the LNA 112 also protects the shunt switch 114. Accordingly, the internal T/R switching techniques described herein provide the added advantage that the additional off-chip ESD protection circuitry used with conventional external T/R switches can be eliminated, further reducing the amount of board area used to implement T/R switching.

The transceiver 110 can include an on-chip inductor 316 (e.g., monolithic inductor) in series with the input terminal 120. In some embodiments, the apparatus 300 may also include an additional off-chip inductor 318 mounted to the PCB in series with the input terminal 120. The on-chip inductor 316, the off-chip inductor 318, and any additional package parasitics combine to form an overall gate inductance, L_{G}. The gate inductance, Lg, may be chosen to tune the performance of the LNA 112 when operating in receive mode.

The apparatus 300 also includes an off-chip shunt capacitor 320 coupled to the PCB in parallel with the antenna 202. The capacitance value, C_{R}, of the capacitor 320 may be selected so that it forms a resonant LC circuit in combination with the gate inductance, L_{G}, when the shunt switch 114 is closed. When the shunt switch 114 closed and the input of the LNA 112 is shorted to ground, the gate inductance L_{G} and the shunt capacitor 320 together form a parallel LC circuit (also referred to as a tank circuit) that resonates at the frequency band of interest. Thus, during transmission mode, the PA 108 sees a large real impedance in parallel to the 50-ohm antenna impedance, which reduces RF power loss through the shunt switch 114 during transmit mode.

During receive mode, when the LNA 112 is active and PA 108 is turned off, the shunt switch 114 is kept open. With the shunt switch 114 open, the output impedance of the inactive PA 108 is now in parallel to the antenna 202 from the perspective of the LNA 112. Since PA matching networks tend to resonate around the operating frequency even when the PA 108 is turned off, the LNA 112 sees a high real impedance in parallel to the impedance of the antenna 202, so very little power is diverted to the PA 108 through the bridge 204. Accordingly, the internal T/R switching design has little impact on the noise figure and gain of the transceiver 100 when operating in receive mode.

As noted above, the bridge 204 between the output terminal 118 and the input terminal 120 can be a board trace, or a series capacitor or inductor. In some embodiments, the bridge 204 may include a series capacitor with self-resonance around the transmit frequency. This would effectively create an AC short between the output terminal 118 and the antenna 202, while providing DC blocking. Additionally, the bridge 204 may also include a series inductor or capacitor selected to improve the RF impedance match seen by the PA 108 at the output terminal 118. For example, if the gate inductance, Lg, is not large enough by itself to generate a sufficiently large real impedance at resonance, an inductor or a capacitor can be included in the bridge 204 to further increase the effective impedance of the resonant LC circuit when the shunt switch 114 is closed.

In some embodiments, the apparatus 300 may also include an additional on-board shunt component 322 coupling the output terminal 118 to ground. The component 322 may be another optional tuning component (e.g., inductor or capacitor) that can be used to further improve the RF impedance match between the PA 108 and the antenna 202.

It will be appreciated that the transceiver 100 is one embodiment of a transceiver in accordance with embodiments of the present disclosure, and that various changes may be made without deviating from the scope of the present disclosure. For example, in this embodiment, the PA 108 is a differential amplifier with a magnetic balun. However, the present techniques may also be implemented with a single-ended amplifier with inductive load or RF choke at its output.

FIG. 4 is a circuit diagram of the transceiver 100 disposed within an apparatus 400 such that the antenna 202 is coupled directly to the output terminal 118 in accordance with some embodiments of the present disclosure. The apparatus 400 may be any suitable electronic device configured for wireless communication. FIG. 4 is a more detailed representation of the example implementation shown in FIG. 2B.

The embodiment shown in FIG. 4 is similar to the embodiment shown in FIG. 3, except that antenna 202 is coupled directly to the output terminal 118 and coupled to the input terminal through the bridge 204. Additionally, an off-chip shunt capacitor 402 is coupled to the PCB in parallel with the antenna 202 at the output terminal 118.

The capacitance value, C_{R}, of the capacitor 402 may be selected so that it forms a resonant circuit in combination with the bridge 204 and the gate inductance, L_{G}, when the shunt switch 114 is closed. When the shunt switch 114 closed and the input of the LNA 112 is shorted to ground, the bridge 204, the gate inductance L_{G}, and the shunt capacitor 402 together form a parallel LC circuit which resonates at the frequency band of interest. Thus, during transmission mode, the PA 108 sees a large real impedance in parallel to the 50-ohm antenna impedance, which reduces RF power loss through the shunt switch 114.

During receive mode, when the LNA 112 is active and PA 108 is turned off, the shunt switch 114 is kept open. When the shunt switch 114 is kept open, the output impedance of the inactive PA 108, the capacitor 402, the bridge 204, and the gate inductance, Lg, forms an impedance matching network between the antenna 202 and the LNA 112.

In some embodiments, the apparatus 400 may also include an additional on-board shunt component 404 coupling the input terminal 120 to ground. The capacitor 404 may be another optional tuning component (e.g., inductor or capacitor) that can be used to further improve the RF impedance match between the LNA 112 and the antenna 202.

It will be appreciated that the transceiver 100 is one embodiment of a transceiver in accordance with embodiments of the present disclosure, and that various changes may be made without deviating from the scope of the present disclosure. For example, as noted above, the present techniques may also be implemented with a single-ended amplifier with inductive load or RF choke at its output.

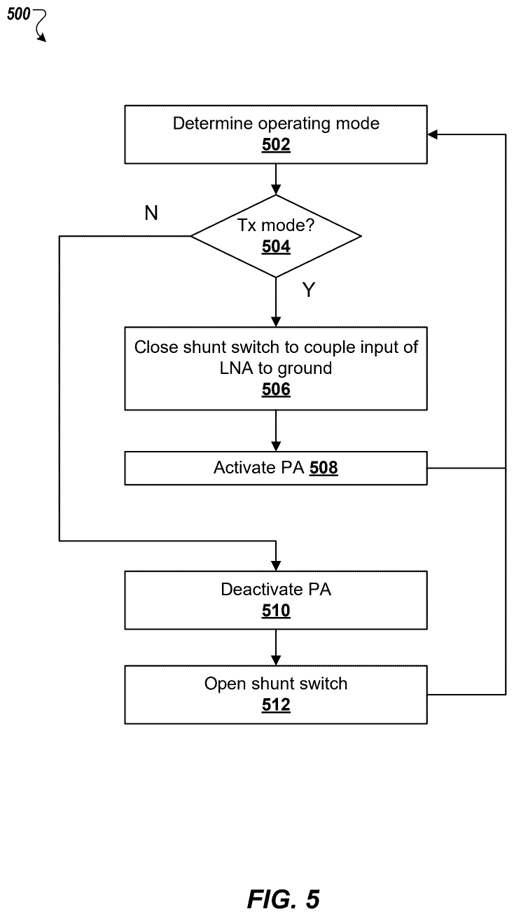

FIG. 5 is a flow diagram of a method 500 for operating an internal (on-chip) T/R switching device, in accordance with some embodiments of the present disclosure. Method 500 may be performed by processing logic that may comprise hardware (e.g., circuitry, dedicated logic, programmable logic, a processor, a processing device, a central processing unit (CPU), a system-on-chip (SoC), etc.), software (e.g., instructions running/executing on a processing device), firmware (e.g., microcode), or a combination thereof. For example, the method 500 may be performed by the controller 116. The method 500 may be performed to control the on-chip T/R switching capability provided by the shunt switch 114 as described in relation to FIGS. 1-4. The method may begin at block 502.

At block 502, a determination is made regarding the transceiver's operating mode. If, at block 504, the transceiver is in transmit mode, the process flow advances to block 506. At block 506, the shunt switch is closed to couple the input of the LNA to ground. After the shunt switch is closed, the process flow advances to block 508 and the power amplifier is activated. The process flow then returns to block 502.

If, at block 504, the transceiver is in receive mode, the process flow advances to block 510. At block 510, the power amplifier is deactivated. After the power amplifier is deactivated, the process flow advances to block 512 and the shunt switch is opened. The process flow then returns to block 502.

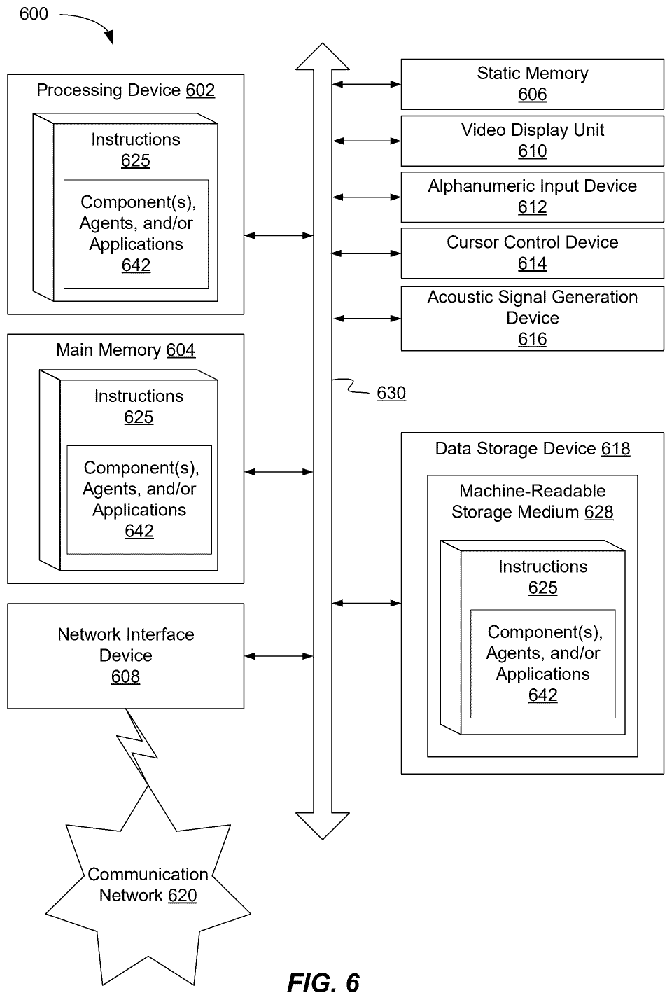

FIG. 6 is a block diagram of an example computing device 600 that may perform one or more of the operations described herein, in accordance with some embodiments. The communication device 600 may include one or more of the example embodiments of the transceiver 100 as described with respect to FIGS. 1-5. Computing device 600 may be connected to other computing devices in a LAN, an intranet, an extranet, and/or the Internet. The computing device may operate in the capacity of a server machine in client-server network environment or in the capacity of a client in a peer-to-peer network environment. The computing device may be provided by a personal computer (PC), a set-top box (STB), a server, a network router, switch or bridge, or any machine capable of executing a set of instructions (sequential or otherwise) that specify actions to be taken by that machine. Further, while only a single computing device is illustrated, the term “computing device” shall also be taken to include any collection of computing devices that individually or jointly execute a set (or multiple sets) of instructions to perform the methods discussed herein.

The example computing device 600 may include a processing device (e.g., a general-purpose processor, a PLD, etc.) 602, a main memory 604 (e.g., synchronous dynamic random-access memory (DRAM), read-only memory (ROM)), a static memory 606 (e.g., flash memory and a data storage device 618), which may communicate with each other via a bus 630.

Processing device 602 may be provided by one or more general-purpose processing devices such as a microprocessor, central processing unit, or the like. In an illustrative example, processing device 602 may include a complex instruction set computing (CISC) microprocessor, reduced instruction set computing (RISC) microprocessor, very long instruction word (VLIW) microprocessor, or a processor implementing other instruction sets or processors implementing a combination of instruction sets. Processing device 602 may also include one or more special-purpose processing devices such as an application specific integrated circuit (ASIC), a field programmable gate array (FPGA), a digital signal processor (DSP), network processor, or the like. The processing device 602 may be configured to execute the operations described herein, in accordance with one or more aspects of the present disclosure, for performing the operations and steps discussed herein.

Computing device 600 may further include a network interface device 608 which may communicate with a communication network 620. The computing device 600 also may include a video display unit 610 (e.g., a liquid crystal display (LCD) or a cathode ray tube (CRT)), an alphanumeric input device 612 (e.g., a keyboard), a cursor control device 614 (e.g., a mouse) and an acoustic signal generation device 616 (e.g., a speaker). In one embodiment, video display unit 610, alphanumeric input device 612, and cursor control device 614 may be combined into a single component or device (e.g., an LCD touch screen).

Data storage device 618 may include a computer-readable storage medium 628 on which may be stored one or more sets of instructions 625 that may include instructions for one or more components, agents, and/or applications 642 for carrying out the operations described herein, in accordance with one or more aspects of the present disclosure. Instructions 625 may also reside, completely or at least partially, within main memory 604 and/or within processing device 602 during execution thereof by computing device 600, main memory 604 and processing device 602 also constituting computer-readable media. The instructions 625 may further be transmitted or received over a communication network 620 via network interface device 608. The network interface device 608 may be a wireless interface where the transceiver 100 discussed herein is implemented.

While computer-readable storage medium 628 is shown in an illustrative example to be a single medium, the term “computer-readable storage medium” should be taken to include a single medium or multiple media (e.g., a centralized or distributed database and/or associated caches and servers) that store the one or more sets of instructions. The term “computer-readable storage medium” shall also be taken to include any medium that is capable of storing, encoding or carrying a set of instructions for execution by the machine and that cause the machine to perform the methods described herein. The term “computer-readable storage medium” shall accordingly be taken to include, but not be limited to, solid-state memories, optical media and magnetic media.

Unless specifically stated otherwise, terms such as “receiving” “acquiring,” “determining,” “performing,” “deploying,” “applying,” “detecting,” “maintaining,” “causing,” or the like, refer to actions and processes performed or implemented by computing devices that manipulates and transforms data represented as physical (electronic) quantities within the computing device's registers and memories into other data similarly represented as physical quantities within the computing device memories or registers or other such information storage, transmission or display devices. Also, the terms “first,” “second,” “third,” “fourth,” etc., as used herein are meant as labels to distinguish among different elements and may not necessarily have an ordinal meaning according to their numerical designation.

Examples described herein also relate to an apparatus for performing the operations described herein. This apparatus may be specially constructed for the required purposes, or it may include a general-purpose computing device selectively programmed by a computer program stored in the computing device. Such a computer program may be stored in a computer-readable non-transitory storage medium.

The methods and illustrative examples described herein are not inherently related to any particular computer or other apparatus. Various general-purpose systems may be used in accordance with the teachings described herein, or it may prove convenient to construct more specialized apparatus to perform the required method steps. The required structure for a variety of these systems will appear as set forth in the description above.

The above description is intended to be illustrative, and not restrictive. Although the present disclosure has been described with references to specific illustrative examples, it will be recognized that the present disclosure is not limited to the examples described. The scope of the disclosure should be determined with reference to the following claims, along with the full scope of equivalents to which the claims are entitled.

As used herein, the singular forms “a”, “an” and “the” are intended to include the plural forms as well, unless the context clearly indicates otherwise. It will be further understood that the terms “comprises”, “comprising”, “includes”, and/or “including”, when used herein, specify the presence of stated features, integers, steps, operations, elements, and/or components, but do not preclude the presence or addition of one or more other features, integers, steps, operations, elements, components, and/or groups thereof. Therefore, the terminology used herein is for the purpose of describing particular embodiments only and is not intended to be limiting.

It should also be noted that in some alternative implementations, the functions/acts noted may occur out of the order noted in the figures. For example, two figures shown in succession may in fact be executed substantially concurrently or may sometimes be executed in the reverse order, depending upon the functionality/acts involved.

Although the method operations were described in a specific order, it should be understood that other operations may be performed in between described operations, described operations may be adjusted so that they occur at slightly different times or the described operations may be distributed in a system which allows the occurrence of the processing operations at various intervals associated with the processing.

Various units, circuits, or other components may be described or claimed as “configured to” or “configurable to” perform a task or tasks. In such contexts, the phrase “configured to” or “configurable to” is used to connote structure by indicating that the units/circuits/components include structure (e.g., circuitry) that performs the task or tasks during operation. As such, the unit/circuit/component can be said to be configured to perform the task, or configurable to perform the task, even when the specified unit/circuit/component is not currently operational (e.g., is not on). The units/circuits/components used with the “configured to” or “configurable to” language include hardware—for example, circuits, memory storing program instructions executable to implement the operation, etc. Reciting that a unit/circuit/component is “configured to” perform one or more tasks, or is “configurable to” perform one or more tasks, is expressly intended not to invoke 35 U.S. C. § 112, sixth paragraph, for that unit/circuit/component. Additionally, “configured to” or “configurable to” can include generic structure (e.g., generic circuitry) that is manipulated by software and/or firmware (e.g., an FPGA or a general-purpose processor executing software) to operate in manner that is capable of performing the task(s) at issue. “Configured to” may also include adapting a manufacturing process (e.g., a semiconductor fabrication facility) to fabricate devices (e.g., integrated circuits) that are adapted to implement or perform one or more tasks. “Configurable to” is expressly intended not to apply to blank media, an unprogrammed processor or unprogrammed generic computer, or an unprogrammed programmable logic device, programmable gate array, or other unprogrammed device, unless accompanied by programmed media that confers the ability to the unprogrammed device to be configured to perform the disclosed function(s).

The foregoing description, for the purpose of explanation, has been described with reference to specific embodiments. However, the illustrative discussions above are not intended to be exhaustive or to limit the present disclosure to the precise forms disclosed. Many modifications and variations are possible in view of the above teachings. The embodiments were chosen and described to best explain the principles of the embodiments and its practical applications, to thereby enable others skilled in the art to best utilize the embodiments and various modifications as may be suited to the particular use contemplated. Accordingly, the present embodiments are to be considered as illustrative and not restrictive, and the present disclosure is not to be limited to the details given herein, but may be modified within the scope and equivalents of the appended claims.

What is claimed is:

1. An apparatus comprising:
a transceiver chip comprising:
a power amplifier coupled to an output terminal of the transceiver chip;
a low noise amplifier coupled to an input terminal of the transceiver chip, wherein the input terminal and the output terminal are separate terminals external to the transceiver chip;
a shunt switch coupled in parallel with the low noise amplifier between the input terminal and ground; and
a control circuitry to activate the shunt switch to couple the input terminal to ground when the power amplifier is turned on; and
an antenna coupled to the transceiver chip and configured to:
provide a Radio Frequency (RF) input signal to the input terminal when the apparatus is in receive mode; and
receive an RF output signal from the output terminal when the apparatus is in transmit mode.

2. The apparatus of claim 1, comprising a bridge component external to the transceiver chip and configured to couple the input terminal with the output terminal.

3. The apparatus of claim 2, wherein the bridge component comprises a conductive trace.

4. The apparatus of claim 2, wherein the antenna is coupled to the input terminal directly and the antenna is coupled to the output terminal through the bridge component.

5. The apparatus of claim 4, comprising a gate inductor coupled to the input terminal and a shunt capacitor coupled to the input terminal in parallel with the antenna, wherein the gate inductor and the shunt capacitor form a parallel LC circuit configured to resonate at an operating frequency of the RF output signal when the apparatus is in transmit mode.

6. The apparatus of claim 4, wherein the bridge component comprises a capacitor or inductor configured to further impedance match the power amplifier to the antenna when the apparatus is in transmit mode.

7. The apparatus of claim 2, wherein the antenna is coupled to the output terminal directly and the antenna is coupled to the input terminal through the bridge component.

8. The apparatus of claim 7, comprising a gate inductor coupled to the input terminal and a shunt capacitor coupled to the output terminal in parallel with the antenna, wherein the shunt capacitor forms a parallel LC circuit in combination with the bridge component and the gate inductor, and wherein the parallel LC circuit is configured to resonate at an operating frequency of the RF output signal when the apparatus is in transmit mode.

9. The apparatus of claim 8, wherein the bridge component is a capacitor or inductor configured to further increase a real impedance of the parallel LC circuit when the apparatus is in transmit mode.

10. The apparatus of claim 1, further comprising:
a transmit/receive switch external to the transceiver chip and coupled between the input terminal, the output terminal, and the antenna; and
additional control circuitry configured to control the transmit/receive switch to:
couple the output terminal to the antenna when the apparatus is in transmit mode; and
couple the input terminal to the antenna when the apparatus is in receive mode.

11. The apparatus of claim 1, wherein the apparatus comprises a software-enabled access point (SoftAP).

12. The apparatus of claim 1, wherein the apparatus comprises in a wireless router.

13. A transceiver chip comprising:
an input terminal configured to receive an input RF signal;
an output terminal separate from the input terminal and configured to transmit an output RF signal;
a power amplifier coupled to the output terminal to generate the output RF signal;
a low noise amplifier coupled to the input terminal to amplify the input RF signal;
a shunt switch coupled in parallel with the low noise amplifier between the input terminal and ground; and
a control circuitry to activate the shunt switch to couple the input terminal to ground when the power amplifier is turned on.

14. The transceiver chip of claim 13, wherein the power amplifier is a differential amplifier, the transceiver chip further comprising a magnetic balun coupled between an output of the differential amplifier and the output terminal.

15. The transceiver chip of claim 13, wherein the power amplifier is a single-ended amplifier, the transceiver chip further comprising an inductive load or RF choke coupled between an output of the single-ended amplifier and the output terminal.

16. The transceiver chip of claim 13, further comprising an Electrostatic Discharge (ESD) protection circuit coupled in parallel with the low noise amplifier between the input terminal and ground.

17. The transceiver chip of claim 13, wherein the transceiver chip is implemented in a software-enabled access point (SoftAP).

18. The transceiver chip of claim 13, wherein the transceiver chip is implemented in a wireless router.

19. A method of operating a transceiver, comprising:
activating a power amplifier during a transmit mode to generate an output RF signal;
prior to activating the power amplifier, closing a shunt switch to couple an input of a low noise amplifier to ground;
deactivating the power amplifier during a receive mode; and
after deactivating the power amplifier, opening the shunt switch to enable the low noise amplifier to receive an RF input signal.

20. The method of claim 19, wherein the power amplifier, the low noise amplifier, and the shunt switch are disposed on a same integrated circuit die.
